(19) United States
(12) Patent Application Publication
(10) Pub. No.: US 2026/0189503 A1
(43) Pub. Date: Jul. 2, 2026

(54) BYPASS ROUTE CACHE FOR A NETWORK ON A CHIP

(71) Applicant: Advanced Micro Devices, Inc., Santa Clara, CA (US)

(72) Inventors: Chintan S. Patel, Austin, TX (US); Jeffrey Lynn Freeman, Austin, TX (US); Eric Christopher Morton, Austin, TX (US)

(73) Assignee: Advanced Micro Devices, Inc., Santa Clara, CA (US)

(21) Appl. No.: 19/006,603

(22) Filed: Dec. 31, 2024

(51) Int. Cl. H04L 45/74

(52) U.S. Cl. CPC H04L 45/742

(57) ABSTRACT

Methods, devices, and systems for information routing. A destination indication corresponding to data is received. The data is transmitted on a routing path based on routing information retrieved from a routing table bypass that includes a routing cache and a match mask. In some implementations, the destination indication comprises at least a portion of a network address. Some implementations include bypassing a routing table based on the routing information being present in the routing cache or the match mask. In some implementations, a total number of entries of the routing cache is fewer than a number of addresses in a working set. In some implementations, the match mask is dynamically programmable. In some implementations, an entry of the match mask includes a bit mask, a bit match and a routing destination associated with at least a portion of an address. In some implementations, the data comprises a packet.

### BACKGROUND

A network on a chip or network-on-chip (NoC) is a network-based communications subsystem on an integrated circuit (IC), typically between modules in a system on a chip (SoC). The modules on the IC are typically semiconductor cores implementing various functions of the SoC.

A router is a networking device which receives and forwards information (e.g., packets) between devices, such as processors, networks, or sub-networks. Typically, an NoC is or includes a router-based packet switching network which forwards packets between or among SoC modules.

A scheduler is a mechanism implemented in some routers (e.g., of an SoC) which determines an order in which to process packets for forwarding.

A routing table is a data structure used in some network devices, such as a router of an NoC, or other routers, switches, or computers, that stores information indicating how to route incoming packets. For example, in some implementations, the destination indicated in each arriving packet is checked against the routing table, which may include information regarding possible routes for different destinations. In some implementations, the NoC or other device determines, e.g., based on the routing table, where to forward packets based on a destination identification (ID)(e.g., indicated in the packet). For example, in some implementations, if a packet arrives at the device (e.g., router), the routing table is consulted to determine where to forward the packet. For example, in some implementations, the routing table indicates an output port of the router, or indicates a next hop (e.g., an intermediate destination), or final destination, for the packet. In some implementations, the routing table lookup process is time-consuming, e.g., especially for large tables and high-throughput networks.

A routing cache is a mechanism implemented in some network devices, such as in a router of an NoC, other routers, switches, or computers, to speed up the process of determining the next hop (or final destination) for packets. For example, in some implementations, a routing cache speeds up this determination by storing frequently used routing information in a fast-access memory. For example, in some implementations, the router or other device first checks the cache cached routing information corresponding to an incoming packet destination (e.g., information that identifies an endpoint in the NoC, such as an ID and/or address). If found, the more time-consuming lookup in the routing table is not performed. In some cases, this provides the advantage of speeding up the routing process, reducing latency and increasing throughput. However, in some implementations, a routing cache is subject to thrashing, scheduling delay, and other types of delay (e.g., where the working set is larger than the routing cache).

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating an example bypass mechanism;

FIG. 4 is a flow chart illustrating example operation of a bypass mechanism;

FIG. 5 is a block diagram illustrating example operation of an example bypass mechanism;

FIG. 6 is a block diagram further illustrating example operation of an example bypass mechanism

FIG. 7 is a block diagram further illustrating example operation of an example bypass mechanism; and

FIG. 8 is a flow chart illustrating example operation of a bypass mechanism.

### DETAILED DESCRIPTION

The number of different network destinations that a router needs to determine over a particular amount of time can be referred to as a working set. In some implementations, if the working set is larger than the number of entries in a routing cache, the routing cache will typically not provide a speed advantage over a routing table lookup, and may in fact decrease performance. Thus, it may be desired to implement a routing cache that is larger than the expected working set. However, in some cases, e.g., if the cache size is too large (e.g., larger than a critical percentage of the size of the routing table), then the cache may become difficult to implement, e.g., in terms of complexity, die size, and/or delay, and may not provide a sufficient (or any) speed advantage over a routing table lookup. Accordingly, in some implementations, it may be desired to provide a mechanism to bypass the routing table and/or scheduler, in some situations. Further, in some implementations, it may be desired to provide a mechanism to implement a routing cache that is smaller than the expected working set while avoiding performance penalties.

Some implementations provide method for information routing. A destination indication corresponding to data is received. The data is transmitted on a routing path based on routing information retrieved from a routing table bypass that includes a routing cache and a match mask.

In some implementations, the destination indication comprises at least a portion of a network address. Some implementations include bypassing a routing table based on the routing information being present in the routing cache or the match mask. In some implementations, a total number of entries of the routing cache is fewer than a number of addresses in a working set. In some implementations, the match mask is dynamically programmable. In some implementations, an entry of the match mask includes a bit mask, a bit match and a routing destination associated with at least a portion of an address. In some implementations, the data comprises a packet. In some implementations, the routing information is retrieved from the routing cache based on both the routing cache and match mask including entries corresponding to the destination indication. In some implementations, the routing cache includes a pinned entry which includes a tag corresponding to an entry of the match mask.

Some implementations provide a device for information routing. The device includes circuitry configured to receive a destination indication corresponding to data. The device also includes circuitry configured to transmit the data on a routing path based on routing information retrieved from a routing table bypass that includes a routing cache and a match mask.

In some implementations, the destination indication comprises at least a portion of a network address. Some implementations include circuitry configured to bypass a routing table based on the routing information being present in the routing cache or the match mask. In some implementations, a total number of entries of the routing cache is fewer than a number of addresses in a working set of the device. In some implementations, the match mask is dynamically programmable. In some implementations, an entry of the match mask includes a bit mask, a bit match and a routing destination associated with at least a portion of an address. In some implementations, the data comprises a packet. In some implementations, the routing information is retrieved from the routing cache based on both the routing cache and match mask including entries corresponding to the destination indication. In some implementations, the routing cache includes a pinned entry which includes a tag corresponding to an entry of the match mask.

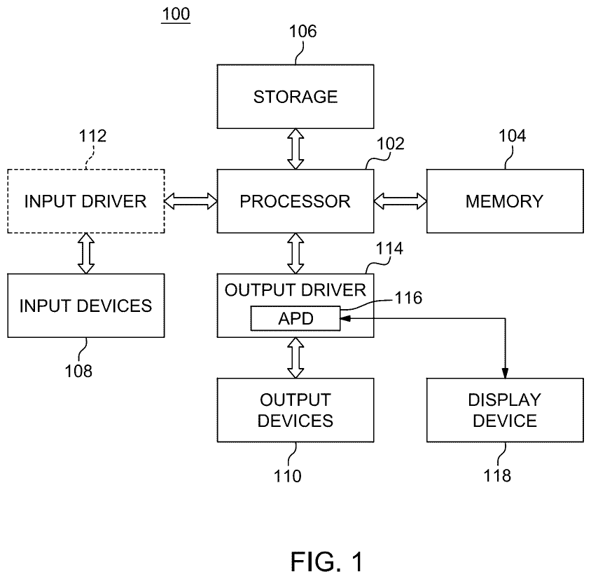

Some implementations include a routing device. The routing device includes circuitry configured to receive a destination indication corresponding to data. The routing device also includes circuitry configured to transmit the data on a routing path based on routing information retrieved from either a routing cache or a match mask. In some implementations, the routing device does not include a routing table. FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

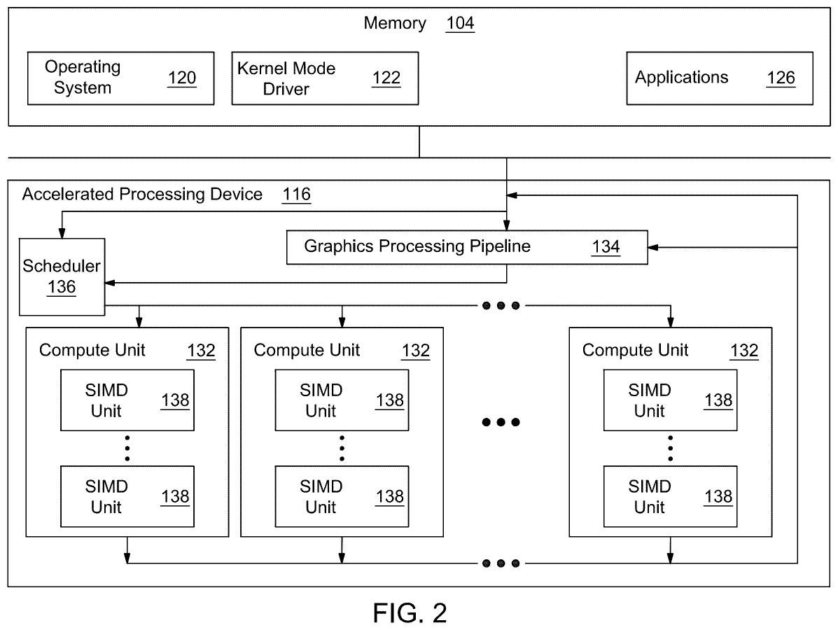

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with or using different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks

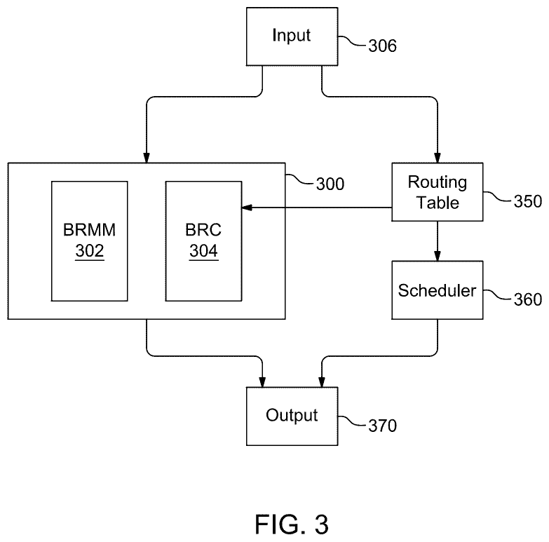

FIG. 3 is a block diagram illustrating an example bypass mechanism 300 according to some implementations. Bypass mechanism 300 is implemented as part of a router and/or NoC in some implementations, and determines whether to bypass a routing table 350 and/or scheduling queue 360 for an incoming packet. Accordingly, in some implementations, bypass mechanism 300 can be referred to as a routing table bypass and/or scheduling queue bypass. Bypass mechanism 300 is implementable using any suitable hardware, such as shown and described with respect to FIG. 1 and/or FIG. 2. Bypass mechanism 300 includes a bypass routing match mask (BRMM) 302 and a bypass routing cache (BRC) 304. The destination information 306 (e.g., information that identifies an endpoint in the NoC, such as an ID and/or address of the endpoint) from an incoming packet is input to BRMM 302 and BRC 304, and if routing information corresponding to the incoming packet destination information 306 is found in either BRMM 302 or BRC 304 (i.e., on a BRC or BRMM hit), the packet bypasses the routing table 350 and/or scheduler 360, and is forwarded to an output 370 (e.g., an output port of the router and/or NoC) corresponding to the routing information. It is noted that in some implementations, any suitable destination indication can be used, such as destination information 306, an address, destination address, network address, IP address, or any other suitable address, indicator, indication, and/or ID of a destination for the packet or other structure.

BRMM 302 includes suitable hardware (e.g., circuitry) and/or software to match the destination information from the incoming packet to routing information by bit masking. For example, in some implementations, BRMM 302 implements a table which includes a bit mask associated with entries in the table. These entries are also each associated with routing information (e.g., information that identifies an endpoint in the NoC, such as an ID and/or address of the endpoint). A bitwise AND operation is applied to the destination information from the incoming packet and the bit masks in the table. If the operation matches the match value for any of the table entries in BRMM 302, the packet has matched that entry. In some implementations, the packet is routed based on the corresponding routing information from BRMM 302. In some implementations, the BRMM “hits” if the following is true:

$$( Endpoint ID \&\& Bit Mask ) == Match \qquad Eq . 1$$

Here, the ID is masked by the bit mask, and if the resulting masked ID is equal to the match value, BRMM 302 hits. It is noted that this expression is only an example, and the functionality can be expressed or computed in any suitable manner. In an example, if the bit mask is 0xFE, then both IDs 0x71 and 0x73 will match 0x1:

$$( Endpoint ID \&\& 0 \times FE ) == 0 \times 1 \qquad Eq . 2$$

In some implementations, a single match mask entry is usable to route multiple different destination IDs (e.g., where they routing is common to more than one destination). In some implementations, this has the advantage of leveraging regularity in the NoC ID assignments where paths are common to destinations that all have a common set of bits (e.g., 0x71 and 0x73 have bit 0 in common in the example of Eq. 2, as can be appreciated from the binary representation of 0x71 (001110001) and 0x73 (0b01110011)).

In other words, in some implementations, the masking mechanism allows each entry of BRMM 302 to potentially correspond to the information indication of a plurality of different destinations. In an example expressed in binary, a bit mask of 0b0001 would match the destination information of any incoming packet with a decimally odd-numbered destination address (e.g., 0b0001, 0b0011, 0b1001, etc., corresponding to decimal 1, 3, 9, etc.)

In some implementations, BRMM 302 is programmable. For example, in some implementations, BRMM 302 is programmed by firmware at the initialization time, or is programmed based on a currently active set of components. In some implementations, BRMM 302 is programmed with the most commonly used routes such that they can always take the bypass route.

BRC 304 is a cache memory (e.g., a fully-associative cache memory) which includes suitable hardware (e.g., circuitry) and/or software to match the destination information from the incoming packet to routing information based on a cache tag. For example, in some implementations, BRC 304 implements a cache which includes cache tags associated with entries in the cache. These entries are also associated with routing information. The destination information from an incoming packet is compared with the cache tags in the cache. If the comparison results in a cache hit, the packet has matched that entry. In some implementations, the packet is routed based on the corresponding routing information from BRC 304. If the comparison results in a cache miss, the packet has not matched any entry, and in some implementations, the routing information for the incoming packet is allocated into BRC 304 based on a routing table lookup. In some implementations, additionally or alternatively, if the comparison results in a cache miss, the routing information for the incoming packet is allocated into BRC 304 based on routing information from BRMM 302, based on a BRMM hit.

In some implementations BRC 304 is pre-loaded. In some implementations, some of the cache entries in BRC 304 are pinned (i.e., cannot be evicted from the cache or otherwise replaced, e.g., during normal operation). In some cases, cache entries are pinned for high priority destinations (e.g., packets for whom the destination implies a real-time quality of service requirement, or other types of quality of service requirement).

In some implementations, if both BRMM 302 and BRC 304 hit, and if the corresponding routing information does not match, routing information is applied based on a tiebreaking policy. For example, in some implementations, routing information from BRC 304 is applied instead of routing information from BRMM 302, if destination information from the incoming packet hits both BRMM 302 and BRC 304. In some implementations, the tiebreaking policy is programmable.

In some implementations, implementing a routing mechanism such as bypass mechanism 300 can have the advantage of facilitating a routing speed increase over a routing table lookup and/or routing scheduler bypass based on a routing cache that is smaller than the working set. In some implementations, a BRC such as BRC 304 provides adaptability as compared with a bitmask, and implementing a BRMM such as BRMM 302 compensates for performance penalties associated with a routing cache being smaller than the working set.

In some implementations, a routing mechanism such as bypass mechanism 300 includes a BRC and/or BRMM which is sized such that the routing mechanism cannot miss. In some implementations, BRMM 302 is sized based on the number of target destinations down each switch, based on the number of most common paths used, and/or based on an implementation specific goal of how many simultaneous matches meet timing goals. In some such implementations, a routing table (such as routing table 350) is omitted. In some such implementations, a scheduler (such as scheduler 360) is also omitted.

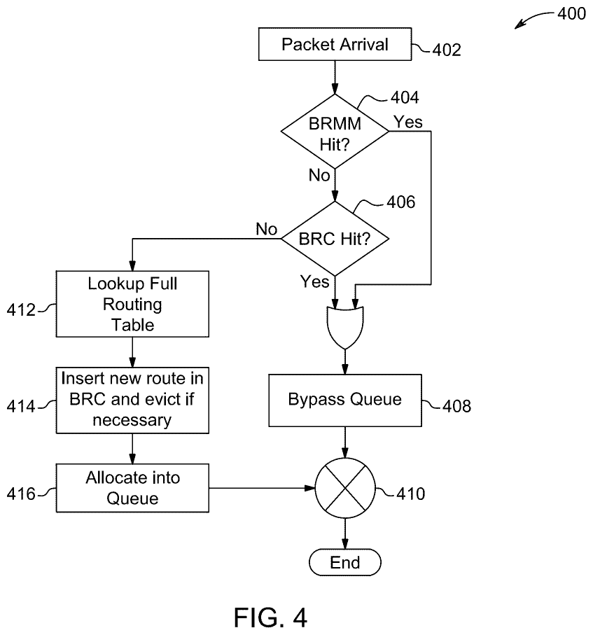

FIG. 4 is a flow chart illustrating example operation 400 of a bypass mechanism, such as bypass mechanism 300. A packet arrives at the router at 402. On condition 404 that the BRMM hits or on condition 406 that the BRC hits, the packet bypasses the scheduling queue at 408 and is routed according to the routing information corresponding to the destination information in the packet at 410. In some implementations, if both BRMM and BRC hit, the packet is routed according to a tiebreaking policy (e.g., prioritizing BRC) at 410. In some implementations, where both BRMM and BRC hit, the route that was determined based on the BRMM hit is kept by the switch such that even if the bypass based on the BRC hit is ultimately unsuccessful (e.g. due to port conflicts or lack of tokens, link down, etc.) it may be used for the non-bypassed route. In other words, in some implementations, the bypass mechanism stashes the bypass route based on the BRMM match to avoid a secondary lookup, which may have the advantage of saving power. In some implementations, this is vice-versa (e.g., where a route determined based on the BRC hit is kept if a bypass based on the BRMM fails, in cases where the tiebreaking policy prioritizes BRMM).

On condition 406 that the BRC does not hit, routing information corresponding to the destination information in the packet is retrieved based on a routing table lookup at 412, and the routing information is inserted into an entry of the BRC at 414, according to any suitable replacement and/or eviction policy if needed, and the packet is allocated into the scheduling queue at 416, for eventual routing according to the routing information at 410.

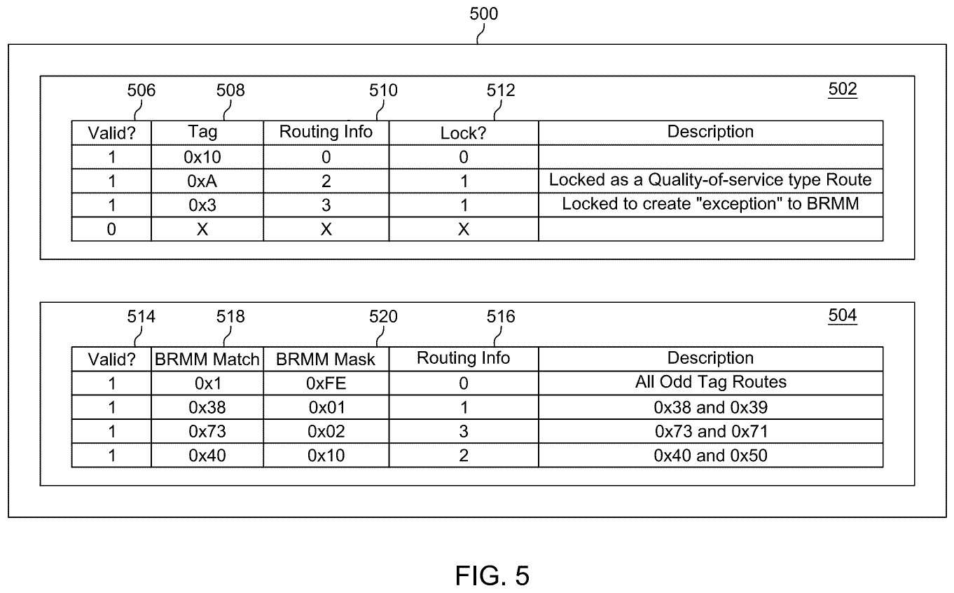

FIG. 5 is a block diagram illustrating example operation of an example bypass mechanism 500, such as shown and described with respect to FIGS. 3 and 4, and includes a BRC 502 and BRMM 504.

In this example, BRC 502 is a cache memory which includes 4 entries (i.e., is “4 deep”). Each entry includes a validity indication 506, and if valid, includes routing information 508 associated with a cache tag 510. Each entry also includes a locking indication 512. In the figure, a description of each entry is provided for purposes of illustration only.

In this example, the first three entries are marked valid, and accordingly, each includes routing information associated with a cache tag. The second and third entries are also marked as locked. In some implementations, the lock indicates that these entries are not subject to replacement on a cache miss if new information is inserted into BRC 502. Here, for example, the second entry is locked as relating to a route having a particular quality of service requirement. In some implementations, this is pre-programmed, or in other implementations, this may be controlled by monitoring quality of service requirements, e.g., in software (such as by the operating system). In other words, either the routing information 510 (e.g., output port 2) or the cache tag 508 (e.g., 0xA) is associated with communications requiring or benefiting from routing table and/or scheduling bypass (e.g., real-time communications). In some implementations, BRC 502 is pre-loaded with this information, and FIG. 5 represents the cold cache condition of BRC 502. In this context, the cold cache condition refers to the condition of BRC 502 prior to operation (e.g., prior to possible insertions to or evictions from BRC 502).

Based on the condition of BRC 502 shown in FIG. 5, a packet having a destination matching tag 508 0x10, 0xA, or 0x3 will hit BRC 502 (unless overridden by a tiebreaking policy). For the sake of example, it is noted that the second entry of BRC 502 is locked as being associated with a cache tag and/or destination that is associated with communications requiring a particular quality of service (e.g., real-time communications). In this example, it is also noted that the third entry is locked to create an “exception” to BRMM 504—i.e., to override the BRMM routing of a packet that hits both BRMM 504 and BRC 502 such that the routing according to BRC 502 is followed. This may correspond, for example, to an implementation where a tiebreaking policy is applied between BRMM 504 and BRC 502 (i.e., in favor of BRC 502).

In this example, BRMM 504 is a match mask device which includes 4 entries (i.e., is “4 deep”). In this example, each entry includes a validity indication 514, and if valid, includes routing information 516 associated with a BRMM match 518 and BRMM mask 520 information. In the figure, a description of each entry is provided for purposes of illustration only.

In some implementations, a BRMM entry is marked invalid as an indication that it is not to be used (e.g., by firmware). In some implementations, a BRMM entry is marked invalid because the NoC is down-binned and/or not all components are active. In some implementations, this has the advantage of avoiding wasteful programming and unnecessary matching operations, e.g., where fewer BRMM entries are needed due to fewer potential matches. In some implementations, validity indications 514 are omitted.

In this example, all four entries are marked valid, and accordingly, each includes valid routing information. In some implementations, BRMM 504 is pre-programmed with this information, and FIG. 5 represents the preprogrammed condition of BRMM 504.

Based on the condition of BRMM 504 shown in FIG. 5, a packet having a destination matching a BRMM match 518, as masked by the corresponding BRMM mask 520, will hit BRMM 504 (unless overridden by a tiebreaking policy). In other words, a packet will hit BRMM 504 (unless overridden by a tiebreaking policy) if each bit of the destination ID matches each bit of the BRMM match 518 of an entry, ignoring those bits that are masked by the BRMM mask.

For the sake of example, it is noted that the first entry of BRMM 504 will result in a BRMM hit for any odd-numbered packet destination (because any odd numbered ID will be TRUE when binary ORed with 0x1, and because any packet at all will be TRUE when binary ANDed with 0xFE). In other words, any ID having a least significant bit of 1 will hit based on the first entry of BRMM 504 because it will match 0x1 (0b 0000 0001) if the bits indicated by the mask value 0xFE (0b 1111 1110) are ignored. In this example, the only bit of the ID that is considered (based on the mask 0xFE) is the least significant bit, which resolves as TRUE if it matches the value of the match (i.e., 1) and thus is odd.

Continuing the example, the second entry will result in a BRMM hit for any packet destination matching 0x38 or 0x39 (because ID 0x38 will be TRUE when binary ORed with 0x38, and because ID 0x39 will be TRUE when binary ANDed with 0x01). In other words, any ID having a value of 0x38 or 0x39 will hit based on the second entry of BRMM 504 because it will match 0x38 (0b 0011 1000) if the bits indicated by the mask value 0x01 (0b 0000 0001) are ignored. In this example, the only bits of the ID that are considered are the most significant seven bits (i.e., the least significant bit is ignored), which resolve to true for either ID 0x38 (0b 0011 1000) or ID 0x39 (0b 0011 1001) since they both have the same most significant seven bits, which match the match value.

Continuing the example further, the third entry will result in a BRMM hit for any packet destination matching 0x73 or 0x71 (because ID 0x73 will be TRUE when binary ORed with 0x73, and because ID 0x71 will be TRUE when binary ANDed with 0x02). In other words, any ID having a value of 0x73 or 0x71 will hit based on the third entry of BRMM 504 because it will match 0x73 (0b 0111 0011) if the bits indicated by the mask value 0x02 (0b 0000 0010) are ignored. In this example, the only bits of the ID that are considered are bits 0 and 2-7 (i.e., bit 1, the second least significant bit) is ignored. Accordingly, this resolves to true for either ID 0x73 (0b 0111 0011) or ID 0x71 (0b 0111 0001) since they both have the same bits 0 and 2-7, which match the match value.

For the last part of the example, the fourth entry will result in a BRMM hit for any packet destination matching 0x40 and 0x50 (because ID 0x40 will be TRUE when binary ORed with 0x40, and 0x50 will be TRUE when binary ANDed with 0x10). In other words, any ID having a value of 0x40 or 0x50 will hit based on the fourth entry of BRMM 504 because it will match 0x40 if the bits indicated by the mask value 0x10 (0b 0001 0000) are ignored. In this example, the only bits considered are bits 0-3 and 5-7 (i.e., bit 4, the fourth least significant bit) is ignored. Accordingly, this resolves true for either ID 0x40 (0b 0100 0000) or ID 0x50 (0b 0101 0000) since they both have the same bits 0-3 and 5-7, which match the match value.

In an example operation, in a first clock cycle (Cycle 0), a packet arrives at the router. A tag 0x10, based on the destination information in the packet, is input to BRC 502 and BRMM 504. Since BRC 502 includes a tag 508 entry corresponding to tag 0x10 (e.g. first entry), this results in a BRC hit, and the routing table is successfully bypassed. The packet is routed to output port 0, per the routing info 510 corresponding to the BRC entry.

In a second clock cycle (Cycle 1), a second packet arrives at the router. A tag 0x38, based on the destination information in the packet, is input to BRC 502 and BRMM 504. Since BRC 502 does not include an entry corresponding to tag 0x38, this results in a BRC miss. However, since BRMM 504 does include an entry corresponding to tag 0x38, entry 2, this results in a BRMM hit, and the routing table is successfully bypassed. The packet is routed to port 1, per the routing info 516 corresponding to the BRMM entry.

In this implementation, this routing information is not inserted into BRC 502, even though a cache miss resulted, since the routing information is available in the BRMM. This can have the advantage of reducing complexity and avoiding unnecessary operations. It is noted however that in some implementations, the BRC is updated based on the miss even with a BRMM hit.

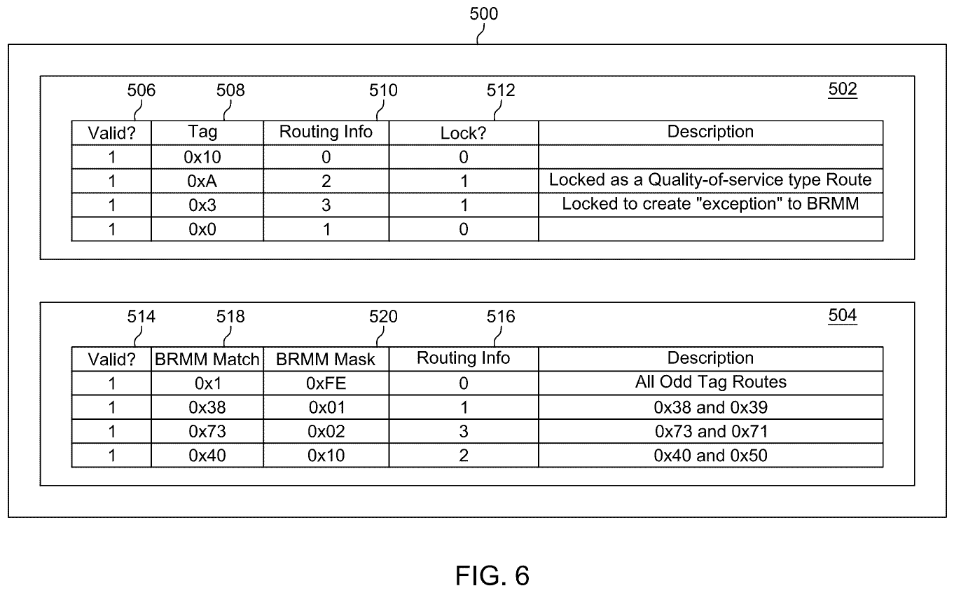

In a third clock cycle (Cycle 2), a third packet arrives at the router. A tag 0x0, based on the destination information in the packet, is input to BRC 502 and BRMM 504. Since neither BRC 502 nor BRMM 504 includes an entry corresponding to tag 0x0 (i.e., 0x0 does not correspond to any tag 508 in BRC 502, and does not hit BRMM 504), this results in both a BRC miss and a BRMM miss. Accordingly, the routing table is not bypassed. The routing information is instead retrieved based on a routing table lookup (e.g., as shown and described with respect to element 350 of FIG. 3), and this retrieved routing information (indicating routing to port 1 (not shown) in this example) is inserted into a new entry in BRC 502 (as shown and described with respect to FIG. 6) based on its replacement policy (e.g., least recently used (LRU), etc.). The third packet is routed to port 1, accordingly.

FIG. 6 is a block diagram illustrating example operation of the example bypass mechanism 500, after the routing information 510 corresponding to tag 0x0 is inserted into BRC 502, see entry 4. In some implementations, entries that are newly filled or replaced based on a BRC miss are not locked (i.e., only programmed or pre-programmed entries are locked). Note, BRMM 504 remains the same (e.g., as originally programmed).

In a fourth clock cycle (Cycle 3), a fourth packet arrives at the router. A tag 0x3, based on the destination information in the packet, is input to BRC 502 and BRMM 504. Since BRC 502 includes an entry (entry 3) with a tag 508 corresponding to tag 0x3, this results in a BRC hit. However, since BRMM 504 also includes an entry (entry 1) with a BRMM Match 518 corresponding to tag 0x3 (because this entry matches all odd tag routes), this also results in a BRMM hit, and the routing table is successfully bypassed. In this example, the BRC entry (entry 3) corresponding to tag 0x3 and the BRMM entry corresponding to tag 0x3 (entry 1) indicate different routing (i.e., to port 3 per BRC routing info 512, and to port 1 per BRMM routing info 516). In this case, the BRC routing takes priority, based on the tiebreaking rule. The fourth packet is routed to port 3, accordingly.

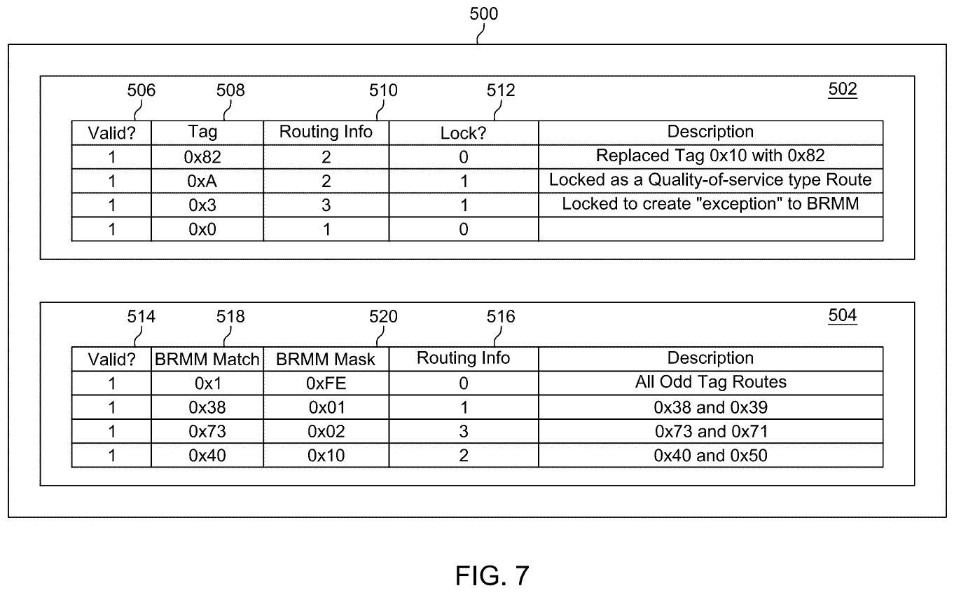

In a fifth clock cycle (Cycle 4), a fifth packet arrives at the router. A tag 0x82, based on the destination information in the packet, is input to BRC 502 and BRMM 504. Since neither BRC 502 nor BRMM 504 includes an entry corresponding to tag 0x82, (i.e., 0x82 does not correspond to any tag 508 in BRC 502, and does not hit BRMM 504), this results in both a BRC miss and a BRMM miss. Accordingly, the routing table is not bypassed. The routing information is instead retrieved based on a routing table lookup (e.g., as shown and described with respect to element 350 of FIG. 3), and this retrieved routing information (indicating routing to port 2 (not shown) in this example) is inserted into an entry of BRC 502 (as shown and described with respect to FIG. 7) that is selected based on the replacement policy of BRC 502 (e.g., least recently used (LRU), etc.). In this example, entry 1 of BRC 502 is selected for replacement based on the replacement policy. The replacement policy, in this example, is to replace the LRU non-locked entry of BRC 502. It is noted that this is only an example, and that any suitable replacement policy is usable in other implementations. The fifth packet is routed to port 2, accordingly.

FIG. 7 is a block diagram illustrating example operation of the example bypass mechanism 500, after the routing information for tag 0x82 is inserted into BRC 502. In some implementations, this entry, which is inserted based on a bypass miss (i.e., was not programmed or pre-programmed) is not locked. Note, BRMM 504 remains the same (e.g., as programmed). In some implementations, such as shown in Figure B, BRMM 504 is not updated based on a bypass miss. In some implementations, BRMM 504 is dynamically programmable (i.e., BRMM entries are modifiable by programming, e.g., during operation).

In some implementations, e.g., if the working set has a guaranteed size that is less than a certain size, and if the BRMM and routing cache are sized properly, then the routing table may not be needed at all.

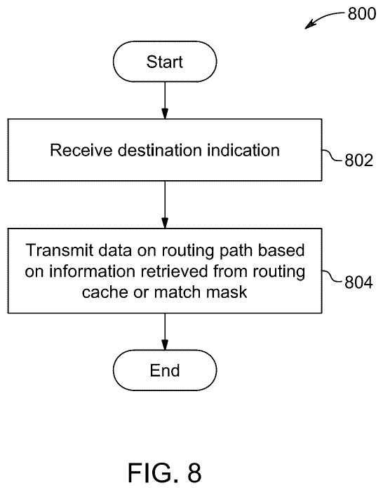

FIG. 8 is a flow chart illustrating an example procedure 800 for information routing.

At 802, a bypass mechanism receives a destination indication. In some implementations, the bypass mechanism is essentially as shown and described with respect to FIG. 3. In some implementations, the destination indication includes at least a portion of a network address or other routing address. In some implementations, the bypass mechanism bypasses a routing table, e.g., based on the routing information being present in the routing cache or the match mask. In some implementations, an entry of the match mask includes a bit mask, a bit match, and a routing destination associated with at least a portion of an address.

At 804, the bypass mechanism transmits data on a routing path based on information retrieved from the routing table bypass. In some implementations, the information is retrieved from a routing cache or match mask of the bypass mechanism. In some implementations, the data is or is carried in a packet.

In some implementations, the information is instead retrieved from the routing cache based on both the routing cache and the match mask including entries corresponding to the destination indication. In some implementations, the routing cache includes a pinned entry which includes a tag corresponding to an entry of the match mask.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, bypass mechanism 300, BRMM 302, BRC 304, BRMM 502, BRC 504), may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for information routing, the method comprising:
receiving a destination indication corresponding to data; and
transmitting the data on a routing path based on routing information retrieved from a routing table bypass that includes a routing cache and a match mask.

2. The method of claim 1, wherein the destination indication comprises at least a portion of a network address.

3. The method of claim 1, further comprising bypassing a routing table based on the routing information being present in the routing cache or the match mask.

4. The method of claim 1, wherein a total number of entries of the routing cache is fewer than a number of addresses in a working set.

5. The method of claim 1, wherein the match mask is dynamically programmable.

6. The method of claim 1, wherein an entry of the match mask includes a bit mask, a bit match and a routing destination associated with at least a portion of an address.

7. The method of claim 1, wherein the data comprises a packet.

8. The method of claim 1, wherein the routing information is retrieved from the routing cache based on both the routing cache and match mask including entries corresponding to the destination indication.

9. The method of claim 1, wherein the routing cache includes a pinned entry which includes a tag corresponding to an entry of the match mask.

10. A device for information routing, comprising:
circuitry configured to receive a destination indication corresponding to data; and
circuitry configured to transmit the data on a routing path based on routing information retrieved from a routing table bypass that includes a routing cache and a match mask.

11. The device of claim 10, wherein the destination indication comprises at least a portion of a network address.

12. The device of claim 10, further comprising circuitry configured to bypass a routing table based on the routing information being present in the routing cache or the match mask.

13. The device of claim 10, wherein a total number of entries of the routing cache is fewer than a number of addresses in a working set of the device.

14. The device of claim 10, wherein the match mask is dynamically programmable.

15. The device of claim 10, wherein an entry of the match mask includes a bit mask, a bit match and a routing destination associated with at least a portion of an address.

16. The device of claim 10, wherein the data comprises a packet.

17. The device of claim 10, wherein the routing information is retrieved from the routing cache based on both the routing cache and match mask including entries corresponding to the destination indication.

18. The device of claim 10, wherein the routing cache includes a pinned entry which includes a tag corresponding to an entry of the match mask.

19. A routing device, comprising:
circuitry configured to receive a destination indication corresponding to data; and
circuitry configured to transmit the data on a routing path based on routing information retrieved from either a routing cache or a match mask.

20. The routing device of claim 19, wherein the routing device does not include a routing table.
